(19) United States
(12) Patent Application Publication
(10) Pub. No.: US 2020/0217025 A1
(43) Pub. Date: Jul. 9, 2020

(54) Weight-limiting roadblock device

(71) Applicant: Huimin He, Qingdao City (CN)

(72) Inventor: Huimin He, Qingdao City (CN)

(21) Appl. No.: 16/816,286

(22) Filed: Mar. 12, 2020

(30) Foreign Application Priority Data
Nov. 11, 2019 (CN) 2019110958397

(51) Int. Cl. E01F 13/04; E01F 13/12; G01G 19/03

(52) U.S. Cl. CPC E01F 13/046; G01G 19/03; E01F 13/123

(57) ABSTRACT

A weight-limiting roadblock device according to the present invention includes a body, wherein the body is provided with a weight detection device, the weight detection device includes a push rod, and the left side of the weight detection device is also provided with an overweight warning device. The overweight warning device includes a railing. The present invention is provided with a putter to detect moving vehicles to avoid the loss of electrical energy caused by the use of sensors. The device also has a roadblock to intercept vehicles that forcibly break through the railings and prevent illegal vehicles from forcibly passing through. The left side of the roadblock is also equipped with an elastic baffle to protect the vehicle being intercepted to prevent safety accidents such as rollover due to interception. This device has accurate measurement, obvious interception effect, and no hidden dangers. It is suitable for many Kind of traffic intersection.

### CROSS-REFERENCES TO RELATED APPLICATIONS

The present application claims priority from Chinese application No. 2019110958397 filed on Sep. 19, 2019 which is hereby incorporated by reference in its entirety.

### TECHNICAL FIELD

The invention relates to the field of weight-limiting roadblocks, in particular to a weight-limiting roadblock device.

### BACKGROUND OF THE INVENTION

At present, the related domestic research is still limited to the two basic methods of height limit or width limit. The real reason that affects the service life of a road is the weight of the road, and weight is one of the main reasons affecting other traffic accidents. Vehicle overload Not only is it easy to cause traffic accidents, but it also causes roads to collapse or even be damaged. It is very dangerous. Existing weight-limiting devices use sensors for detection. The power consumption is large and the barrier effect is not obvious. Device for solving the above problems.

### BRIEF SUMMARY OF THE INVENTION

### Technical Problem

The existing weight-limiting device has the advantages of simple process, large power consumption, and ineffective barrier effect.

A weight-limiting roadblock device according to the present invention includes a body, and a weight detection device is provided on the right side of the body. The weight detection device includes a detection cavity on the right side of the body, and a pressure is provided in the detection cavity. Block and pusher, when the vehicle passes the pressure block, the pressure block moves downward, if the vehicle is not overloaded, it can pass normally, if the vehicle is overloaded, the pressure block contacts the pusher and pushes the The push rod moves to the left, a power transmission cavity is provided on the left side of the weight detection device, and an overweight warning device is provided in the power transmission cavity. The overweight warning device includes a solid block in the power transmission cavity. A solid block is fixed on the solid block, a first moving groove is also provided in the power transmission cavity, and the push rod is slidably connected to the first moving groove. When the traveling vehicle is overloaded, the push rod is The right movement drives the solid block and the fixed block to move upward to raise a road block to intercept the vehicle. A road block interception device is provided on the left side of the overweight warning device, and the road block interception device includes an upper side of the power transmission cavity. Move And in the power transmission cavity, a roadblock is provided in the moving cavity, an elastic baffle plate is provided in the power transmission cavity, and steel nails are provided on the upper end surface of the roadblock, if an overloaded vehicle passes the roadblock forcibly, The barricade block moves upward to the road surface to block an illegal vehicle. The barricade block moves upward while driving the elastic baffle plate to move up to the road surface, blocking the vehicle and preventing the vehicle from rolling over.

The weight detecting device further includes a first moving block slidably connected to the first moving groove. A spring is fixed on the right end surface of the first moving block, and the right side of the spring and the first moving groove are fixed. The right end wall is fixedly connected, a lever is hinged on the first moving block, a sliding groove is provided at the lower end of the lever, a sliding pin is provided in the sliding groove, and a support pin and a fixing plate are fixed on the lever. A T-shaped block is hinged on the fixing plate, a hydraulic cavity is provided on the right side of the lever, the right end of the T-shaped block is located in the hydraulic cavity, and the hydraulic cavity is filled with liquid, and the right end wall of the hydraulic cavity is provided through The pipeline is transported so that when the overloaded vehicle passes, the pressure block moves downwards, pushing the push rod to move to the left, so that the T block moves to the right to squeeze the liquid.

Wherein, the overweight warning device further includes a first transmission cavity located in the transmission pipeline and the same as the transmission pipeline, the first transmission cavity is provided with a pushing block fixedly connected to the solid block, and the fixing block A first rotating shaft is rotatably connected to the upper shaft, a railing is fixedly connected to the first rotating shaft, a second moving groove is provided on the left side of the solid block, and the first rotating shaft extends downward into the second moving groove and A spline sleeve is sleeved, and a second rotation shaft is also fixed on the first rotation shaft, so that the liquid flows into the first transmission cavity through the conveying pipe to push the pushing block upward, so that the first rotation shaft moves upward. Intercept the overloaded vehicle above the road.

Wherein, the roadblock intercepting device further includes a pull wire fixedly wound on the second rotating shaft, a third moving groove is provided on the left side of the second rotating shaft, and the pulling wire extends left into the third moving groove and A second moving block is fixedly connected, and a first gear is meshedly connected to the lower end surface of the second moving block. A second rotating shaft is fixed at the shaft center of the first gear, and the second rotating shaft is fixedly located at the second rotating shaft. A first bevel gear on the front side of the first gear, a second bevel gear is meshedly connected to the lower side of the first bevel gear, a third rotating shaft is fixed at the axis of the second bevel gear, and the third rotating shaft is A first transmission bevel gear is extended and fixedly connected to the lower side of the first transmission bevel gear. A second transmission bevel gear is meshed with the left side of the first transmission bevel gear. A transmission shaft is fixed at the shaft center of the second transmission bevel gear. A third bevel gear extends axially to the left of the moving cavity and is fixedly connected with a fourth bevel gear on the upper side of the third bevel gear. A fourth rotating shaft is fixed at the center of the fourth bevel gear. And the barricade block is threadedly connected with the fourth rotating shaft, so A second transmission cavity is provided on the left side of the moving cavity. The transmission axis extends left into the second transmission cavity and is fixedly connected with a fifth bevel gear. A sixth cone is meshedly connected to the upper side of the fifth bevel gear. A gear, a hollow shaft is fixed at the center of the sixth bevel gear, a second gear is meshed with the lower end surface of the first moving block, and a fifth shaft is fixed at the center of the second gear; A first pulley is extended rearwardly and fixedly connected to the five-rotation axis. A second pulley is provided on the left side of the first pulley, and the first pulley and the second pulley are connected by a belt. A sixth rotating shaft is fixed at the place, and a third gear located on the front side of the second pulley is also fixed on the sixth rotating shaft. An elastic baffle is meshed with the left side of the third gear. When forcibly passing, the third moving groove pulls the second moving block to drive the first gear to rotate, so that the transmission shaft rotates to drive the fourth shaft to rotate, so that the roadblock moves upward to the road surface. Vehicle is blocked while A moving block moves the second gear to rotate, so that the third gear rotates to move the elastic baffle upward into the hollow shaft, and the transmission shaft rotates to drive the sixth bevel gear to rotate, so that The hollow shaft continues to move up to the road to protect the intercepting vehicle.

The beneficial effects of the present invention are: the present invention is provided with a push rod to detect moving vehicles, to avoid the loss of electric energy caused by the use of sensors, and a roadblock is provided in the device to intercept vehicles forcibly breaking through the railings to prevent illegal vehicles from forcibly Through, an elastic baffle is also provided on the left side of the roadblock to protect the intercepted vehicle from safety accidents such as rollover due to interception. This device has accurate measurement, obvious interception effect, and no hidden dangers. It is suitable for Various traffic intersections.

### BRIEF DESCRIPTION OF THE DRAWINGS

For ease of explanation, the present invention is described in detail by the following specific embodiments and the accompanying drawings.

FIG. 1 is a schematic diagram of the overall structure of a weight-limiting roadblock device according to the present invention; FIG.

FIG. 2 is an enlarged schematic view of the “A” structure of FIG. 1;

FIG. 3 is an enlarged schematic view of the “B” structure of FIG. 1;

FIG. 4 is a schematic structural diagram of the “C-C” direction of FIG. 1; FIG.

FIG. 5 is a schematic structural diagram of the “D-D” direction of FIG. 1; FIG.

FIG. 6 is a schematic structural diagram of the “E-E” direction of FIG. 1.

### DETAILED DESCRIPTION OF THE INVENTION

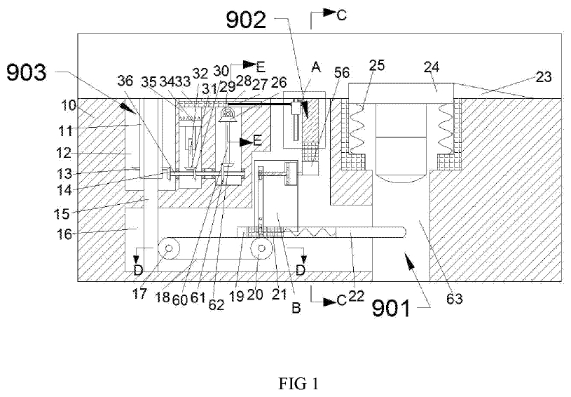

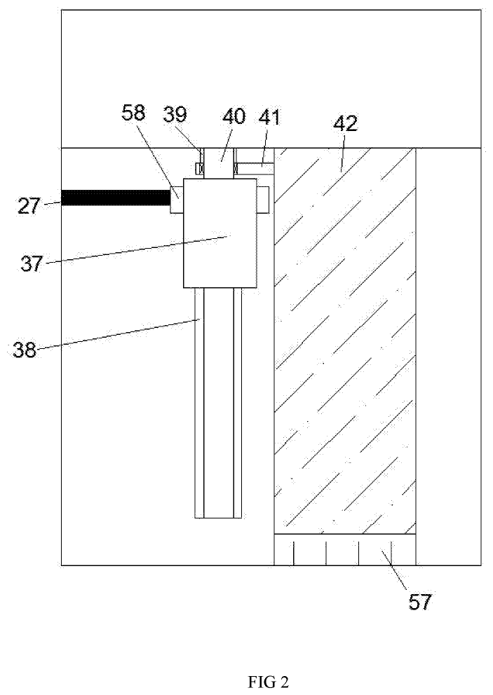

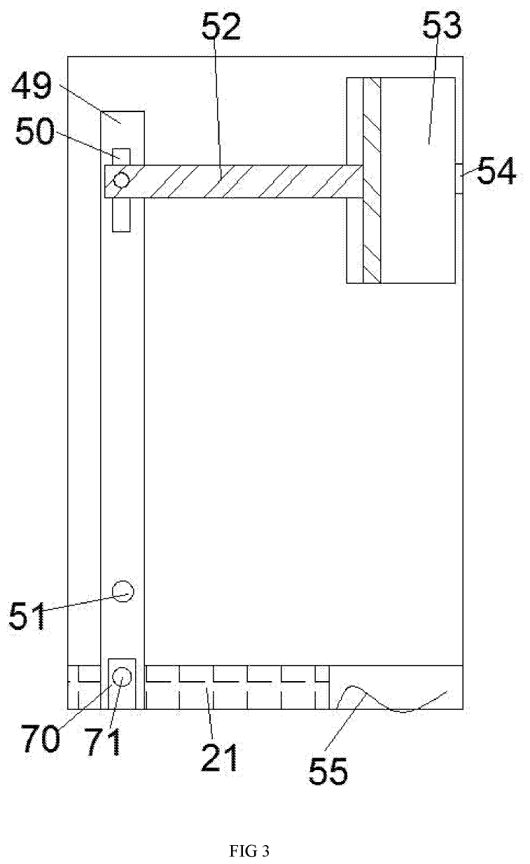

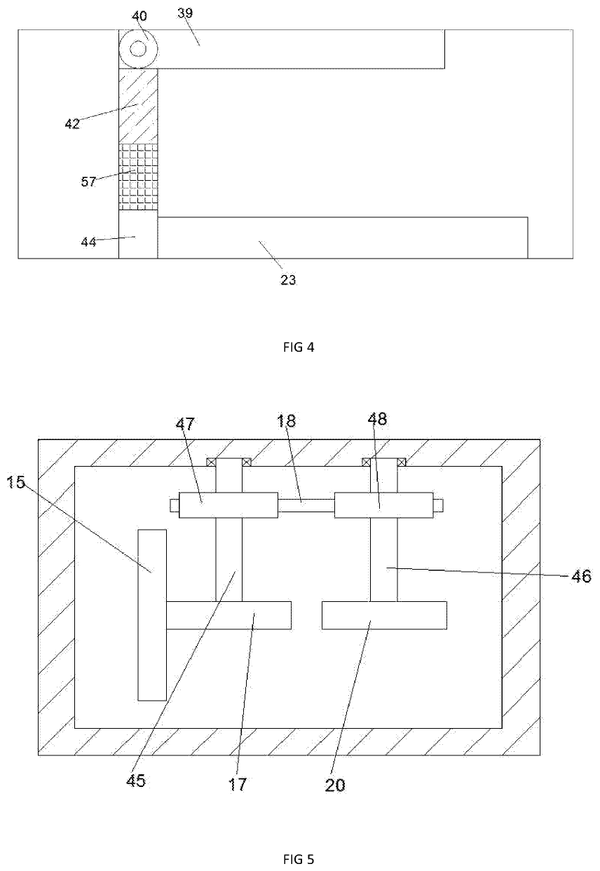

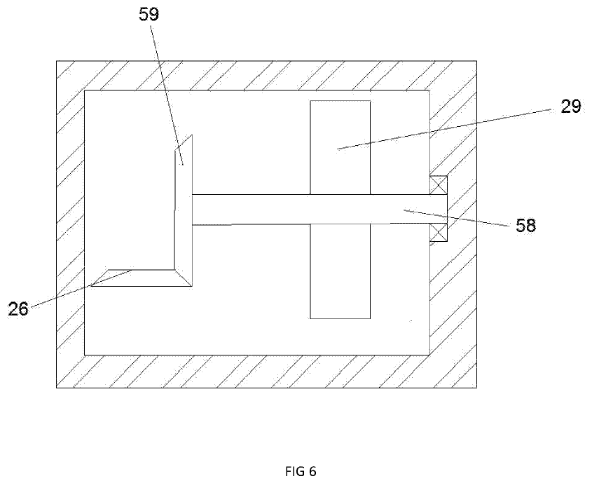

The present invention is described in detail below with reference to FIGS. 1 to 6. For convenience of description, the orientation described below is defined as follows: the up-down, left-right, front-back direction described below is consistent with the up-down, left-right, front-back direction of the projection relationship of FIG. 1 itself.

The invention relates to a weight-limiting roadblock device, which is mainly used for chemical wastewater treatment. The invention will be further described below with reference to the accompanying drawings of the invention:

A weight-limiting roadblock device according to the present invention includes a body 10, and a weight detection device 901 is provided on the right side of the body 10, and the weight detection device 901 includes a detection cavity 63 located on the right side of the body 10. A pressure block 24 and a push rod 22 are provided in the detection cavity 63. When the vehicle passes the pressure block 24, the pressure block 24 moves downward, and if the vehicle is not overloaded, it can pass normally. If the vehicle is overloaded, the The pressure block 24 is in contact with the push rod 22 and pushes the push rod 22 to move to the left. A power transmission cavity 16 is provided on the left side of the weight detection device 901, and an overweight warning device 902 is provided in the power transmission cavity 16. The overweight warning device 902 includes a solid block 42 in the power transmission cavity 16, a fixed block 41 is fixed on the solid block 42, and a first moving groove 19 is also provided in the power transmission cavity 16. The push rod 22 is slidably connected to the first moving groove 19. When the traveling vehicle is overloaded, the push rod 22 moves to the right to drive the solid block 42 and the fixed block 41 to move upward to raise a road block to the vehicle. For interception, a roadblock interception device 903 is provided on the left side of the overweight warning device 902, The roadblock intercepting device 903 includes a moving cavity 35 located on the upper side of the power transmitting cavity 16 and a power transmitting cavity 16. The moving cavity 35 is provided with a barricade block 34, and the power transmitting cavity 16 is provided with elasticity. The baffle plate 15 is provided with steel nails on the upper end surface of the barricade block 34. When an overloaded vehicle forcibly passes the barricade, the barricade block 34 moves up to the road surface to block illegal vehicles, and the barricade block 34 moves upward while The elastic baffle plate 15 is driven to move up to the road surface, blocking the vehicle, and avoiding accidents such as rolling over of the vehicle.

According to an embodiment, the weight detection device 901 is described in detail below. The weight detection device 901 further includes a first moving block 21 slidably connected to the first moving groove 19, and a right end surface of the first moving block 21 is fixed. A spring 55 is provided, and the right side of the spring 55 is fixedly connected to the right end wall of the first moving groove 19. A lever 49 is hinged on the first moving block 21, and a sliding groove 70 is provided at the lower end of the lever 49. A sliding pin 71 is provided in the sliding groove 70. A support pin 51 and a fixing plate 50 are fixed on the lever 49. A T-shaped block 52 is hinged on the fixing plate 50. A hydraulic chamber 53 is provided on the right side of the lever 49. The right end of the T-shaped block 52 is located in the hydraulic chamber 53 and the hydraulic chamber 53 is filled with liquid. The right end wall of the hydraulic chamber 53 is provided with a transmission pipe 54 therethrough, so that when an overloaded vehicle passes, the The pressing block 24 moves downward, and pushes the push rod 22 to move to the left, so that the T-shaped block 52 moves to the right to squeeze the liquid.

According to the embodiment, the overweight warning device 902 will be described in detail below. The overweight warning device 902 further includes a first transmission cavity 56 which is located on the conveying pipe 54 and is the same as the conveying pipe 54. A pushing block 57 is fixedly connected to the solid block 42. A first rotating shaft 40 is rotatably connected to the fixing block 41. A railing 39 is fixedly connected to the first rotating shaft 40. The left side of the solid block 42 is provided. There is a second moving slot 38, the first rotating shaft 40 extends downward into the second moving slot 38 and is sleeved with a spline sleeve 37, and a second rotating shaft 58 is also fixed on the first rotating shaft 40, so that The liquid flows into the first transmission cavity 56 through the conveying pipe 54 to push the pushing block 57 upward, so that the first rotating shaft 40 moves upward above the road surface to intercept the overloaded vehicle.

According to the embodiment, the roadblock intercepting device 903 will be described in detail below. The roadblock intercepting device 903 further includes a pull wire 27 fixedly wound on the second rotating shaft 58, and a third moving groove is provided on the left side of the second rotating shaft 58. 28. The pull wire 27 extends to the left into the third moving slot 28 and is fixedly connected with a second moving block 33. A first gear 29 is engaged with the lower end face of the second moving block 33. A second rotating shaft 58 is fixed at the 29 axis center, and a first bevel gear 59 located on the front side of the first gear 29 is fixed on the second rotating shaft 58. The lower side of the first bevel gear 59 is meshed and connected. The second bevel gear 26 is provided with a third rotating shaft 60 fixed at an axial center thereof. The third rotating shaft 60 extends downward and is fixedly connected with a first transmission bevel gear 62. The first transmission bevel A second transmission bevel gear 61 is meshedly connected to the left side of the gear 62. A transmission rotating shaft 36 is fixed at the axis of the second transmission bevel gear 61. The transmission rotating shaft 36 extends to the left of the moving cavity 35 and is fixedly connected. There is a third bevel gear 30, and a fourth bevel gear 31 is meshed with the upper side of the third bevel gear 30 A fourth rotating shaft 32 is fixed at the axis of the fourth bevel gear 31, and the barricade block 34 is threadedly connected to the fourth rotating shaft 32. A second transmission cavity 12 is provided on the left side of the moving cavity 35. The transmission rotating shaft 36 extends to the left into the second transmission cavity 12 and is fixedly connected with a fifth bevel gear 14. A sixth bevel gear 13 is meshed with the upper side of the fifth bevel gear 14. A hollow shaft 11 is fixed at the shaft center of the bevel gear 13, a second gear 20 is meshedly connected to the lower end surface of the first moving block 21, and a fifth rotating shaft 46 is fixed at the shaft center of the second gear 20. The five rotating shafts 46 extend rearward and are fixedly connected with a first pulley 48, a second pulley 47 is provided on the left side of the first pulley 48, and the first pulley 48 and the second pulley 47 are connected by a belt 18, so A sixth rotating shaft 45 is fixed at the axial center of the second pulley 47, and a third gear 17 located on the front side of the second pulley 47 is fixed on the sixth rotating shaft 45. The elastic baffle plate 15 is meshedly connected, so that when an overloaded vehicle is forced to pass, the third moving groove 28 pulls the second The moving block 33 drives the first gear 29 to rotate, so that the transmission shaft 36 rotates to drive the fourth shaft 32 to rotate, so that the barricade block 34 moves upward to the road surface to block the vehicle, while the first movement The movement of the block 21 drives the second gear 20 to rotate, so that the third gear 17 rotates to drive the elastic baffle plate 15 to move upward into the hollow shaft 11, and the transmission shaft 36 rotates to drive the sixth bevel gear 13 turns, so that the hollow shaft 11 continues to move up to the road surface to protect the intercepting vehicle.

The following describes the steps of using a weight-limiting roadblock device in detail in conjunction with FIG. 1 to FIG. 6:

Initially, the elastic baffle plate 15, barricade block 34, first rotating shaft 40, and solid block 42 are all located underground. If the passing vehicle is not overweight, it will pass normally and the device will be in the initial state;

If the vehicle is overweight, the pressure block 24 moves downward to contact the push rod 22 and pushes the push rod 22 to the left, so that the first moving block 21 moves to the left and the slide pin 71 moves to the left, and the lower end of the lever 49 tilts to the left. The upper end is inclined to the right, so that the T-shaped block 52 moves to the right and squeezes the liquid in the hydraulic chamber 53 to the right. It enters the first transmission chamber 56 through the conveying pipe 54 and pushes the pushing block 57 to move upward, so that the solid block 42 moves upward to drive The fixed block 41 moves upward, so that the first rotating shaft 40 moves upward to the road surface to block the vehicle. If the overloaded vehicle stops at this time, the roadblock is not triggered;

If the overloaded vehicle is forced to pass, the rotation of the first rotating shaft 40 drives the second rotating shaft 58 to rotate, so that the pull wire 27 is pulled to the right, and the second moving block 33 moves to the right to drive the first gear 29 to rotate, so that the second rotating shaft 58 is rotated, and then the first A bevel gear 59 rotates to drive the second bevel gear 26 to rotate, so that the third rotation shaft 60 rotates, and then the first transmission bevel gear 62 rotates to drive the second transmission bevel gear 61 to rotate, so that the transmission bevel shaft 36 rotates, and then the third bevel gear 30 rotates Drive the fourth bevel gear 31 to rotate, so that the fourth rotation shaft 32 rotates, and then the road block 34 moves up to the road surface to intercept the vehicle;

The first moving block 21 moves to drive the second gear 20 to rotate, so that the fifth rotation shaft 46 rotates, and then the first pulley 48 rotates to drive the belt 18 to rotate, so that the second pulley 47 rotates, and then the sixth rotation shaft 45 rotates to drive the third gear 17 to rotate So that the elastic baffle plate 15 moves upward into the hollow shaft 11 and meshes with the hollow shaft 11, the transmission shaft 36 rotates to drive the fifth bevel gear 14 to rotate, so that the sixth bevel gear 13 rotates, and then the hollow shaft 11 rotates to drive the elastic baffle plate 15 to continue Move up to the road to protect the intercepting vehicle. After the interception is completed, the device returns to the initial state.

The beneficial effects of the present invention are: the present invention is provided with a push rod to detect moving vehicles, to avoid the loss of electric energy caused by the use of sensors, and a roadblock is provided in the device to intercept vehicles forcibly breaking through the railings to prevent illegal vehicles from forcibly Through, an elastic baffle is also provided on the left side of the roadblock to protect the intercepted vehicle from safety accidents such as rollover due to interception. This device has accurate measurement, obvious interception effect, and no hidden dangers. It is suitable for Various traffic intersections.

In the above manner, those skilled in the art can make various changes according to the working mode within the scope of the present invention.

1. A weight-limiting roadblock device, including a body;
A weight detection device is provided on the right side of the body, and the weight detection device includes a detection cavity on the right side of the body. The detection cavity is provided with a pressure block and a push rod. When the vehicle passes the pressure block, The pressure block moves downwards and can pass normally if the vehicle is not overloaded. If the vehicle is overloaded, the pressure block contacts the push rod and pushes the push rod to move to the left. The left side of the weight detection device is provided. There is a power transmission cavity. An overweight warning device is provided in the power transmission cavity. The overweight warning device includes a solid block in the power transmission cavity. A fixed block is fixed on the solid block. A first moving slot is also provided, and the push rod is slidably connected to the first moving slot. When the traveling vehicle is overloaded, the push rod moves to the right to drive the solid block and the fixed block to move upward to rise. The roadblock is intercepted by a roadblock. A roadblock interception device is provided on the left side of the overweight warning device, and the roadblock interception device includes a moving cavity located on the upper side of the power transmission cavity and the power transmission cavity and the moving cavity. With An obstacle block, an elastic baffle plate is provided in the power transmission cavity, and steel nails are provided on the upper end surface of the road block block. If an overloaded vehicle forcibly passes the road block, the road block block moves upward to the road surface to block illegal vehicles, When the roadblock moves upward, the elastic baffle is moved upward to the road surface, blocking the vehicle, and avoiding accidents such as the vehicle overturning.

2. The weight-limiting roadblock device according to claim 1, wherein the weight detection device further comprises a first moving block slidably connected to the first moving slot;
A spring is fixed on the right end surface of the first moving block, a right side of the spring is fixedly connected to a right end wall of the first moving groove, a lever is hinged on the first moving block, and a sliding groove is provided on the lower end of the lever. A sliding pin is provided in the sliding groove, a support pin and a fixing plate are fixed on the lever, a T-shaped block is hinged on the fixed plate, a hydraulic cavity is provided on the right side of the lever, and a right end of the T-shaped block is provided. It is located in the hydraulic chamber, and the hydraulic chamber is filled with liquid. The right end wall of the hydraulic chamber is provided with a delivery pipe, so that when an overloaded vehicle passes, the pressure block moves downwards, pushing the push rod toward Moving left causes the T block to move to the right to squeeze the liquid.

3. The weight-limiting roadblock device according to claim 1, wherein the overweight warning device further comprises a first transmission cavity located in the transmission pipeline and the same as the transmission pipeline;
The first transmission cavity is provided with a pushing block fixedly connected to the solid block, a first rotating shaft is rotatably connected to the fixed block, a railing is fixedly connected to the first rotating shaft, and a left side of the solid block is provided. A second moving groove, wherein the first rotating shaft extends downward into the second moving groove and is sleeved with a spline sleeve, and a second rotating shaft is also fixed on the first rotating shaft, so that the liquid passes through the conveyance. The pipeline flows into the first transmission cavity to push the pushing block upward, so that the first rotation axis moves upward above the road surface to intercept the overloaded vehicle.

4. The weight-limiting roadblock device according to claim 1, wherein the roadblock intercepting device further comprises a pull wire fixedly wound on the second rotating shaft;
A third moving groove is provided on the left side of the second rotating shaft, and the pull wire extends to the left of the third moving groove and is fixedly connected with a second moving block. A first end of the second moving block is meshed with the first moving block. A gear, a second rotating shaft is fixed at the center of the first gear shaft, a first bevel gear located on the front side of the first gear is fixed on the second rotating shaft, and the lower side of the first bevel gear is meshed and connected There is a second bevel gear, a third rotating shaft is fixed at the shaft center of the second bevel gear, the third rotating shaft extends downward and is fixedly connected with a first transmission bevel gear, and the left side of the first transmission bevel gear A second transmission bevel gear is meshed and connected, and a transmission shaft is fixed at the shaft center of the second transmission bevel gear. The transmission shaft extends left into the moving cavity and is fixedly connected with a third bevel gear. A fourth bevel gear is meshingly connected to the upper side of the third bevel gear, a fourth rotating shaft is fixed at the shaft center of the fourth bevel gear, and the road block is threadedly connected with the fourth rotating shaft;
A second transmission cavity is provided on the left side of the moving cavity, and the transmission rotation axis extends to the left of the second transmission cavity and is fixedly connected with a fifth bevel gear. A six-bevel gear, a hollow shaft is fixed at the center of the sixth bevel gear, a second gear is meshed with the lower end surface of the first moving block, and a fifth shaft is fixed at the center of the second gear. A fifth pulley extends rearwardly and is fixedly connected with a first pulley, a second pulley is provided on the left side of the first pulley, and the first pulley and the second pulley are connected by a belt, and the second pulley A sixth rotating shaft is fixed at the shaft center;
A third gear located on the front side of the second pulley is also fixed on the sixth rotating shaft, and an elastic baffle is meshedly connected to the left side of the third gear, so that when the overloaded vehicle passes forcibly, the third gear The moving groove pulls the second moving block to drive the first gear to rotate, so that the transmission shaft rotates to drive the fourth shaft to rotate, so that the barricade block moves up to the road surface to block the vehicle, and the first A moving block moves the second gear to rotate, so that the third gear rotates to move the elastic baffle upward into the hollow shaft, and the transmission shaft rotates to drive the sixth bevel gear to rotate, so that The hollow shaft continues to move up to the road to protect the intercepting vehicle.
